(19) United States
(12) Patent Application Publication
(10) Pub. No.: US 2026/0017111 A1
(43) Pub. Date: Jan. 15, 2026

(54) IMAGE RENDERING METHOD, APPARATUS, DEVICE, AND MEDIUM

(71) Applicant: Beijing Zitiao Network Technology Co., Ltd., Beijing (CN)

(72) Inventors: Shiyang Zhang, Beijing (CN); Jing Du, Beijing (CN); Yao Zhang, Beijing (CN)

(21) Appl. No.: 18/869,817

(22) PCT Filed: Aug. 29, 2023
(86) PCT No.: PCT/CN2023/115576

§ 371 Date: Sep. 19, 2025

(30) Foreign Application Priority Data
Sep. 16, 2022 (CN) 202211129282.6

(51) Int. Cl. G06F 9/50; G06T 15/00

(52) U.S. Cl. CPC G06F 9/5044; G06T 15/005

(57) ABSTRACT

According to embodiments of the present disclosure, there are provided an image rendering method and apparatus, a device, and a medium. The image rendering method includes determining a first performance associated with a local rendering mode and a second performance associated with a cloud rendering mode. The method further includes determining, at least partially based on the first performance and the second performance, a target rendering mode from the local rendering mode and the cloud rendering mode for executing a rendering task. The method further includes executing the rendering task based on the determined target rendering mode. In this way, a user can select between the local rendering mode and the cloud rendering mode according to a change in a rendering environment, and fully utilize respective advantages of the two modes, thereby improving the rendering efficiency.

The present application claims priority to Chinese Patent Application No. 202211129282.6, filed on Sep. 16, 2022, and entitled “IMAGE RENDERING METHOD, APPARATUS, DEVICE, AND MEDIUM”, which is incorporated herein by reference in its entirety.

### FIELD

Example embodiments of the present disclosure generally relate to the field of computers, and in particular to an image rendering method and apparatus, a device, and a computer-readable storage medium.

### BACKGROUND

Image rendering is a very important link in the field of image processing. A better visual experience effect can be achieved for an image through a rendering technology. Therefore, the rendering technology has been widely used in recent years. The conventional rendering technology supports a local rendering mode and a cloud rendering mode. In the local rendering mode, a user needs to pre-install a rendering program locally, and execute a corresponding rendering task by running a local rendering engine/rendering node. In the cloud rendering mode, the user uses a cloud rendering engine/rendering node to execute a rendering task. Further, the local rendering mode has relatively high requirements for the local hardware performance of the user, while the cloud rendering mode requires a good network state of the user.

In the conventional rendering technology, the user selects the local rendering mode or the cloud rendering mode in advance as needed, and cannot change during the execution of the rendering task. Such an operation lacks flexibility, and is especially not suitable for a scenario where the rendering environment changes.

### SUMMARY

In a first aspect of the present disclosure, an image rendering method is provided. The method includes determining a first performance associated with a local rendering mode and a second performance associated with a cloud rendering mode. The method further includes determining, at least partially based on the first performance and the second performance, a target rendering mode from the local rendering mode and the cloud rendering mode for executing a rendering task. The method further includes executing the rendering task based on the target rendering mode.

In a second aspect of the present disclosure, an image rendering apparatus is provided. The apparatus includes a performance determination module, configured to determine a first performance associated with a local rendering mode and a second performance associated with a cloud rendering mode. The apparatus further includes a target rendering mode selection module, configured to determine, at least partially based on the first performance and the second performance, a target rendering mode from the local rendering mode and the cloud rendering mode for executing a rendering task. The apparatus further includes a rendering task execution module, configured to execute the rendering task based on the target rendering mode.

In a third aspect of the present disclosure, an electronic device is provided. The device includes at least one processing unit; and at least one memory, the at least one memory being coupled to the at least one processing unit and storing instructions executable by the at least one processing unit. The instructions, when executed by the at least one processing unit, cause the device to perform the method of the first aspect.

In a fourth aspect of the present disclosure, a computer-readable storage medium is provided. A computer program is stored on the medium, and the computer program is executed by a processor to implement the method of the first aspect.

It should be understood that the content described in the Summary section is not intended to limit key or important features of the embodiments of the present disclosure, nor is it used to limit the scope of the present disclosure. Other features of the present disclosure will become readily understandable through the following description.

### BRIEF DESCRIPTION OF THE DRAWINGS

The above and other features, advantages, and aspects of embodiments of the present disclosure will become more apparent in conjunction with the accompanying drawings and with reference to the following detailed description. In the drawings, the same or similar reference signs denote the same or similar elements, where:

FIG. 1A is a schematic diagram of an example environment in which embodiments of the present disclosure can be applied:

FIG. 1B is a schematic diagram of another example environment in which embodiments of the present disclosure can be applied;

FIG. 2 is a flowchart of an image rendering process according to some embodiments of the present disclosure:

FIG. 3 is a block diagram of an image rendering apparatus according to some embodiments of the present disclosure; and

FIG. 4 is a block diagram of a device capable of implementing multiple embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and embodiments of the present disclosure are only for exemplary purposes, and are not intended to limit the scope of protection of the present disclosure.

In the description of the embodiments of the present disclosure, the term “include/comprise” and similar terms should be understood as open inclusion, that is, “include/comprise but not limited to”. The term “based on” should be understood as “at least partially based on”. The term “an embodiment” or “the embodiment” should be understood as “at least one embodiment”. The term “some embodiments” should be understood as “at least some embodiments”. Other explicit and implicit definitions may be included below.

It would be appreciated that the data involved in the technical solutions of the present disclosure (including but not limited to the data itself, data acquisition or use) shall comply with the requirements of corresponding laws, regulations and relevant provisions.

It would be appreciated that before using the technical solutions disclosed in the embodiments of the present disclosure, the types, scope of use, usage scenarios, and the like of the personal information involved in the present disclosure should be informed to users and the users' authorization should be obtained in an appropriate manner in accordance with the relevant laws and regulations.

For example, when receiving an active request from a user, a prompt message is sent to the user to explicitly prompt the user that the operation requested by the user will need to acquire and use the user's personal information. Therefore, the user can independently choose whether to provide personal information to the software or hardware such as an electronic device, an application, a server, or a storage medium that executes the operation of the technical solution of the present disclosure according to the prompt message.

As an optional but non-restrictive implementation, in response to receiving an active request from a user, the prompt message is sent to the user, for example, in a pop-up window. The prompt message may be presented in the pop-up window in text. In addition, the pop-up window may also carry a selection control for the user to select “Agree” or “Disagree” to provide personal information to the electronic device.

It would be appreciated that the above process of notifying and obtaining the user's authorization is merely illustrative and does not limit the implementation of the present disclosure. Other methods that meet the relevant laws and regulations may also be applied to the implementation of the present disclosure.

In the present disclosure, the term “local rendering” is sometimes also referred to as “client rendering” or “client side rendering”, which refers to a process of executing a rendering task by running a local rendering engine/rendering node.

In the present disclosure, the term “cloud rendering” is sometimes also referred to as “cloud side rendering”, which refers to a process of executing a rendering task by running a rendering engine/rendering node on a cloud (that is, a server side).

As discussed in the present disclosure, the rendering technology has been widely used in recent years. With the development of rendering technology and the expansion of application scenarios, people's demands for rendering services are also increasing, such as support for multiple types of rendering tasks, real-time viewing of rendering results, low latency of rendering tasks, high-quality images of rendering results, and the like. Therefore, how to provide better service experience has become the focus of the industry.

Further, in the conventional rendering technology, the user may choose to execute the rendering task through the local rendering mode or the cloud rendering mode. In the local rendering mode, the user pre-installs the rendering program locally and executes the corresponding rendering task by running the rendering engine/rendering node locally. The advantage of the local rendering mode is that the rendering result (sometimes also referred to as a rendering video stream) does not need to be transmitted via a network, thereby avoiding latency and image quality loss caused by network transmission. However, the local rendering mode requires the user to pre-install the rendering program and has relatively high requirements for the local hardware performance of the user (such as a computing device with high computing power). Further, due to the limitation of the rendering program itself, the local rendering mode has limited support for the rendering type. In addition, in a real rendering environment, the data to be rendered of the user may be stored locally or on the cloud. When the data to be rendered is stored on the cloud, the user still needs to download a large amount of data to be rendered.

In the cloud rendering mode, the user does not need a local computing device with high computing power, nor does the user need to pre-install the rendering program. In addition, when the data to be rendered is stored on the cloud, the user does not need to download a large amount of data to be rendered. In this way, fast rendering experience can be achieved. However, the disadvantage of the cloud rendering mode is that the rendering result needs to be transmitted to the user via the network. Therefore, transmission latency and image quality loss caused by network transmission have become the main factors affecting the user experience in the cloud rendering mode.

Further, in the conventional rendering technology, the local rendering mode and the cloud rendering mode are operated independently as two independent modes. For example, the user pre-installs a first client for the local rendering mode and is simultaneously configured with a second client that interacts with the cloud rendering platform. The user chooses to execute the rendering task through the first client or the second client. However, the real rendering environment is complex and changeable. As an example, the user determines to use the local rendering mode and downloads a large amount of data to be rendered from the network in advance, but finds that the first client does not support the rendering task type when running the first client, or finds that the user's hardware resources are insufficient to support the rendering task during running. As another example, the user chooses to use the cloud rendering mode and runs the second client. However, the network environment deteriorates during the execution of the rendering task (for example, the network is interrupted or the bandwidth is limited), resulting in the inability to continue to execute the rendering task. In the above scenarios, the user has to exit the current rendering task and choose another rendering mode to re-execute the rendering task.

It can be seen that the conventional rendering technology lacks flexibility and cannot adapt to the complex and changeable real rendering environment. Therefore, there is a need to provide a more flexible rendering solution that can make full use of the respective advantages of the local rendering mode and the cloud rendering mode.

According to some embodiments of the present disclosure, an image rendering solution is provided. In this solution, the performances of the local rendering mode and the cloud rendering mode can be evaluated, and the local rendering mode and the cloud rendering mode are selected to execute the rendering task according to the performance evaluation result. In this way, the respective advantages of the local rendering mode and the cloud rendering mode are fully utilized, and the user experience is improved.

### Example Environment

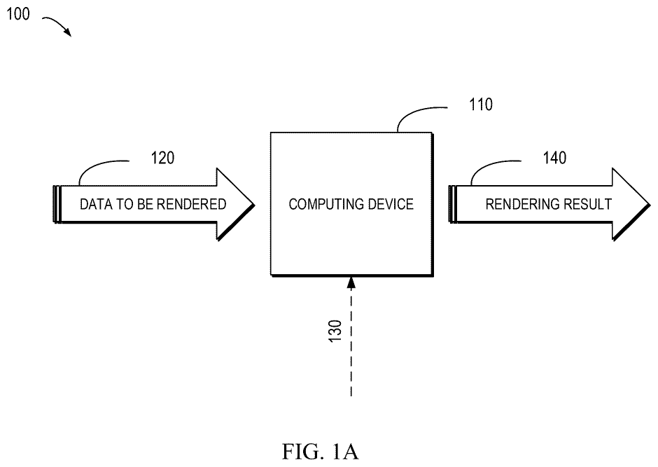

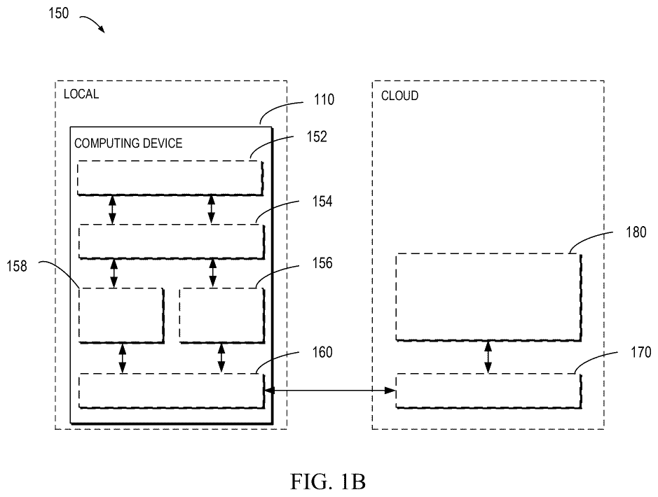

FIG. 1 shows a schematic diagram of an example environment 100 in which embodiments of the present disclosure can be implemented. The environment 100 involves an image processing environment, which includes a computing device 110. As shown in FIG. 1, the computing device 110 receives data 120 to be rendered and outputs a rendering result 140. In the present disclosure, the computing device 110 may be any device/apparatus/module capable of executing a rendering task. The embodiments of the present disclosure are not limited in this respect.

In some example embodiments, the computing device 110 may obtain the data 120 to be rendered and/or store the rendering result 140 in a database/memory located in the computing device 110 or a database/memory located outside the computing device 110 (such as a storage platform that may be a general data download service platform that may provide download services for multiple data format files). The embodiments of the present disclosure are not limited in this respect.

In some embodiments, the computing device 110 may support both the local rendering mode and the cloud rendering mode. Further, the computing device 110 may dynamically select and/or switch between the local rendering mode and the cloud rendering mode. In some embodiments, the selection and/or switching of the target rendering mode may be determined by the computing device 110.

Alternatively, the computing device 110 may also determine the target rendering mode based on a user selection 130 for determining the target rendering mode. In some embodiments, the user selection 130 may be transmitted to the computing device 110 through wired communication or wireless communication. In some example embodiments, the computing device 110 may also receive the user selection 130 input by the user through an input device (including but not limited to, for example, a mouse, a keyboard, a stylus, a touch screen, etc.) coupled to the computing device 110.

In some embodiments, the user may run an application such as a virtual livestream or a virtual meeting on the computing device 110. In these specific application scenarios, the user may deploy at least one image acquisition device at the computing device 110, such as a camera device, to acquire audio and video image data of the user. Further, in these specific application scenarios, in addition to the main screen display, there will also be other virtual screens to display additional video streams or image information. In addition, the user may also have requirements such as a virtual or rendered background. For example, the user expects to change the background to a specific scene, such as a specific meeting room, a starry sky, or the like.

In this case, the user usually needs to transmit one or more of the following types of data for rendering: audio and video image data collected by the image acquisition device, image data or algorithm data for rendering operations, transparent channel data, and other custom types of data, etc. The data are respectively included in multiple different data streams.

FIG. 1B shows a schematic diagram of another example environment 150 in which embodiments of the present disclosure can be implemented. For ease of discussion, the environment 150 shown in FIG. 1B will be described with reference to the environment 100 of FIG. 1A. As shown in FIG. 1B, the environment 150 is schematically divided into a local part and a cloud part.

In some embodiments, the cloud includes a cloud rendering platform 180 and a cloud data interaction layer 170. The cloud rendering platform 180 includes a rendering engine and/or a rendering node for executing a rendering task. The rendering engine and/or the rendering node may be developed by a third party or independently developed by a cloud rendering service provider. The embodiments of the present disclosure are not limited in terms of the source of the rendering engine and/or the rendering node.

In some embodiments, the rendering engine and/or the rendering node include a traffic layer, a rendering engine layer, and an engine plugin layer. In this way, flexible and extensible rendering services can be implemented.

The cloud data interaction layer 170 is used to implement data interaction with the local side. In some embodiments, the cloud data interaction layer 170 may include a streaming module server for transmitting a video stream such as the rendering result 140 to the local side.

As shown in FIG. 1B, the local side includes the computing device 110. Optionally, in some embodiments, the computing device 110 is further configured with a user interface 152, and the user interface 152 is used to present rendering information related to the execution of the rendering task. An example of the rendering information is information indicating the first performance associated with the local rendering mode and/or the second performance associated with the cloud rendering mode. Another example of the rendering information is information indicating the current rendering mode, such as the local rendering mode or the cloud rendering mode. Another example of the rendering information is a presentation interface of the rendering result. Other examples of the rendering information include a mode switching reminder, an execution progress of the rendering task, an estimated execution time of the rendering task, and the like.

In some embodiments, the user interface 152 may further include interactive operation elements, such as an option for determining the target rendering mode, an option for specifying the data to be rendered, an option for configuring various parameters (for example, a rendering type, a rendering image quality, etc.) of the rendering task, and the like.

It should be understood that the above examples of the rendering information and the interactive operation elements are only for the purpose of illustration and description. In other embodiments, the rendering information and the interactive operation elements may include any information and elements related to the execution of the rendering task. Further, these information and elements may be presented in one or more visual elements such as an interface, a pop-up window, a hover box, and a menu. Further, each presented visual element may be selected, enlarged, reduced, or hidden in response to an instruction from a user. An example of the user's instruction is a touch operation on the shown corresponding visual element, including but not limited to clicking, sliding, hovering, and a predetermined gesture. Another example of the user's instruction is a voice instruction. Another example of the user's instruction is a user instruction input through an input device (including a mouse, a keyboard, a stylus, a touchpad, etc.). In addition, when the user device is a portable electronic device, the user's instruction may also be a user action, including but not limited to holding the portable electronic device horizontally. In short, the embodiments of the present disclosure are not limited in the form of expression and the way of interaction of the visual elements.

In addition, in some embodiments, the computing device 110 includes a local rendering module 158 and a cloud rendering module 156, which are respectively configured to execute a rendering task through the local rendering mode and the cloud rendering mode.

In some embodiments, the local rendering module 158 is configured with a rendering engine and/or a rendering node for executing a rendering task. In addition, the rendering engine and/or the rendering node in the local rendering module 158 may be implemented in the same implementation manner as the rendering engine and/or the rendering node in the cloud rendering platform 180. Further, when implemented, the rendering engine and/or the rendering node in the local rendering module 158 and the rendering platform 180 may be compatible with the requirements of both the local rendering mode and the cloud rendering mode. In this way, the local rendering mode and the cloud rendering mode can be switched more smoothly, and the local rendering process and the cloud rendering process can be maintained based on the same solution.

In some embodiments, the local rendering module 158 and the cloud rendering module 156 are connected to a rendering interface layer 154, where the rendering interface layer 154 is configured to implement interaction between the user interface 152 and the local rendering module 158 and the cloud rendering module 156, including rendering data and rendering instructions, and the like.

In addition, the rendering interface layer 154 may include an interactive protocol module for protocol adaptation. Alternatively or additionally, the rendering interface layer 154 may further include a shared storage space for storing the data 120 to be rendered and/or the rendering result 140. In this way, when the rendering mode is switched, the data 120 to be rendered and/or the rendering result 140 may be shared by the subsequent rendering mode.

In some embodiments, the computing device 110 further includes a local data interaction layer 160 configured to implement data interaction with the cloud. In some embodiments, the local data interaction layer 160 may include a streaming module client for receiving image data (such as the rendering result 140) from the cloud. In some embodiments, the local data interaction layer 160 may further include a download storage device for storing the data 120 to be rendered that is downloaded from the cloud.

In addition, in some embodiments, the computing device 110 may further include a local performance test module (not shown) configured to collect information for evaluating the performances of the local rendering mode and the cloud rendering mode. Correspondingly, the cloud may also include a cloud performance test module (not shown) configured to collect information for evaluating the performances of the local rendering mode and the cloud rendering mode. In some embodiments, the local performance test module and the cloud performance test module may exchange values of performance parameters and/or test data, and the like, to determine the first performance associated with the local rendering mode and the second performance associated with the cloud rendering mode.

It should be understood that FIG. 1A and FIG. 1B only show an example image processing environment. In other embodiments, the image processing environment may include more or fewer network elements/modules. For example, any of the network elements/modules shown in FIG. 1B is not necessary and may be omitted according to actual needs. In addition, the number and connection relationships of the network elements/modules shown in FIG. 1B are only illustrative and schematic. The embodiments of the present disclosure are not limited in this respect.

### Example Process

Some example embodiments of the present disclosure will be described below with reference to the accompanying drawings.

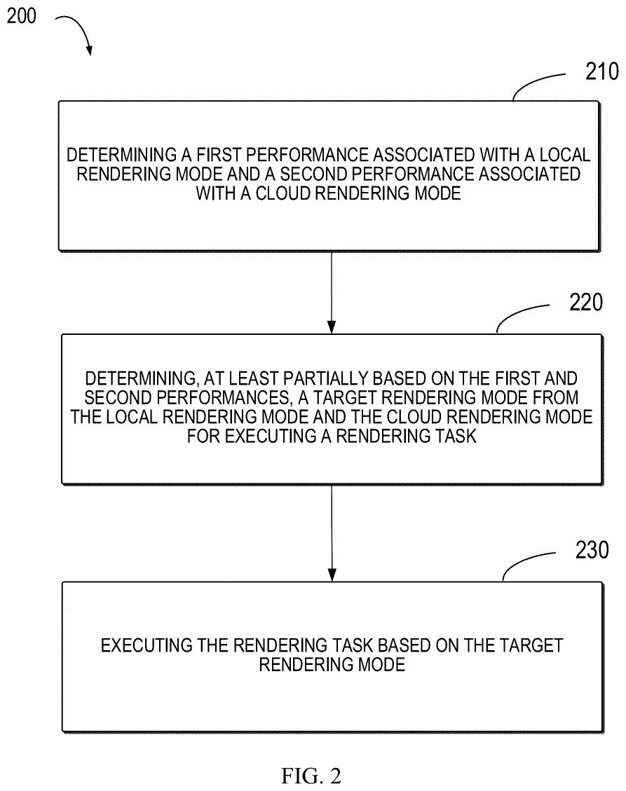

FIG. 2 shows a flowchart of an image processing process 200 according to some embodiments of the present disclosure. For ease of discussion, the discussion will be made with reference to the environment 100 of FIG. 1A and the environment 150 of FIG. 1B. The image processing process 200 may be implemented at the computing device 110.

It should be understood that although the process 200 is discussed with reference to the environment 100 of FIG. 1A and the environment 150 of FIG. 1B, as already discussed in the present disclosure, the environment 100 and the environment 150 are only example environments of the present disclosure. Therefore, the environment 100 and the environment 150 should not be construed as limiting the implementation environment of the process 200. Further, although specific operations in the process 200 are performed by specific network elements/modules, in other embodiments, corresponding operations may also be implemented by other network elements/modules. The embodiments of the present disclosure are not limited in this respect.

At block 210, the computing device 110 determines a first performance associated with a local rendering mode and a second performance associated with a cloud rendering mode. In some embodiments, the computing device 110 determines the first performance and the second performance before the rendering task is run. Alternatively or additionally, the computing device 110 periodically or continuously determines the first performance and the second performance during the execution of the rendering task. Alternatively or additionally, the computing device 110 triggers the determination of the first performance and the second performance in response to a corresponding predefined event being detected during the execution of the rendering task.

An example of the predefined event is a user input, such as a user inputting an instruction of expecting to view the first performance and the second performance. Another example of the predefined event is the detection of insufficient local hardware resources, such as a high CPU occupancy rate and insufficient remaining storage space of a memory. Another example of the predefined event is the detection of a deterioration of network performance, such as a network connection interruption, a weakening of a network connection signal strength, or insufficient network bandwidth. It should be understood that the above examples of the predefined events are only illustrative. In other embodiments, the computing device 110 may trigger the operation of determining the first performance and the second performance in response to other predefined events. The embodiments of the present disclosure are not limited in this respect.

In this way, the computing device 110 can obtain the performance of the local rendering mode and the performance of the cloud rendering mode respectively, which provides a basis for the selection and switching of the target rendering mode. Next, example processes for determining the first performance and the second performance will be described separately.

### Determining the First Performance

In some embodiments, the rendering task is executed by a local computing device, where the computing device 110 is the local computing device itself or a part of the local computing device. An example of the local computing device is a personal computer. Other examples of the local computing device include a smart phone, a smart watch, smart glasses, a smart helmet, a notebook computer, a tablet computer, a personal digital assistant, or any other suitable electronic device.

In some embodiments, determining the first performance includes obtaining at least one hardware performance parameter (that is, at least one hardware performance parameter of the local computing device) associated with the local rendering mode.

It would be appreciated that the hardware performance parameter in the present disclosure refers to any appropriate parameter that can characterize and measure the performance of the local rendering mode. An example of the hardware performance parameter is a central processing unit (CPU) performance. Another example of the hardware performance parameter is a graphics processing unit (GPU) performance. Other examples of the hardware performance parameter include a capacity of a storage (such as a memory, a hard disk) and a disk read/write speed.

In some embodiments, the computing device 110 obtains a value of the at least one hardware performance parameter. In the present disclosure, the value of the at least one hardware performance parameter may be expressed as a plurality of types of parameters. In a specific embodiment, the computing device 110 obtains hardware information (such as a hardware model, a hardware device number, etc.) of the local computing device, including but not limited to a CPU model, a GPU model, and a memory model. Based on the obtained hardware information of the local computing device, the computing device 110 may obtain a value of the corresponding hardware performance parameter. In this way, the computing device 110 can obtain the value of the at least one hardware performance parameter without performing any additional detection.

Alternatively or additionally, the computing device 110 may obtain the value of the at least one hardware performance parameter through a test program, including but not limited to a running speed, a disk read/write speed, and a rendering execution speed. In this way, the computing device 110 can obtain more accurate values of the hardware performance parameters.

Alternatively or additionally, different hardware performance parameters may also have different weights, and the first performance may also be calculated based on the weight of the at least one hardware performance parameter. In some embodiments, the weights of different hardware performance parameters are pre-configured, such as the CPU performance having a high first weight, the GPU performance having a medium second weight, and the memory having a low third weight.

Alternatively, the weights of different hardware performance parameters may also be dynamically determined based on the type of the rendering task. For example, for a rendering task with high real-time requirements, the weight of the running speed may be strengthened, while for a rendering task with a large amount of data to be rendered but low real-time requirements, the weight of the memory capacity may be strengthened. It should be understood that the above example of the dynamic configuration rule is only for illustrative purposes. In other embodiments, the weights may be adjusted and configured according to other standards. The embodiments of the present disclosure are not limited in this respect. In this way, the first performance can better reflect the execution performance in the local rendering mode.

In some embodiments, the first performance may be measured by a score. Specifically, different values of the hardware performance parameter correspond to different scores. As a specific embodiment, the first performance may be calculated by the following equation (1).

$$First performance = Score of first hardware parameter * First weight + \text{} … + Score of Mth hardware parameter * Mth weight \qquad ( 1 )$$

where M is an integer greater than or equal to 1. In some embodiments, the determination rule of the first performance may be pre-configured and stored. Table 1 below shows an example of the determination rule of the first performance.

TABLE 1
Example of determination rule of the first performance

| Hardware | | | |
|---|---|---|---|
| performance | | Model/ | |
| parameter | Weight | Test value | Score |
| CPU | W1 (For example, | Model 1 | S1 (For example, |
| | the first weight) | | the first score) |
| | | Model 2 | S2 (For example, |
| | | | the second score) |
| GPU | W2 (For example, | Model 1 | S3 (For example, |
| | the second weight) | | the third score) |
| | | Model 2 | S4 (For example, |
| | | | the fourth score) |
| . . . | . . . | . . . | . . . |
| Memory | W3 (For example, | First capacity | S5 (For example, |
| capacity | the third weight) | | the fifth score) |
| Disk read/ | W4 (For example, | Speed range | S6 (For example, |
| write speed | the fourth weight) | (For example, | the sixth score) |
| | | the first | |
| | | speed range) | |

In the specific embodiment in Table 1, if the CPU model of the local computing device is model 1, the GPU model is model 2, the storage capacity is the first capacity, and the disk read/write speed belongs to the first speed range, the first performance will be calculated as: the first score*the first weight+the fourth score*the second weight+the fifth score*the third weight+the sixth score*the fourth weight through equation (1).

It should be understood that the determination rule of the first performance in Table 1 is only an example. In other words, the numbers and values of the hardware performance parameters, the weights, the models/test values, and the scores shown in Table 1 are all illustrative. In other embodiments, the determination rule of the first performance may be properly defined according to actual needs. It should also be understood that the above equation (1) is also only an example. In other embodiments, the first performance may also be determined by other equations. More importantly, the characterization of the first performance by the score is only illustrative. In other embodiments, the first performance may also be characterized by other parameters, such as a performance level. In short, the present disclosure is not limited in the specific implementation of determining the first performance through the value and the weight of the at least one hardware performance parameter.

In some embodiments, the calculation process of the first performance may be performed by the computing device 110. In this way, the computing device 110 does not need to transmit additional information, such as hardware information and test results, to the cloud performance test module.

Alternatively or additionally, in some embodiments, the calculation process of the first performance may also be calculated by the cloud performance test module. In this case, the cloud performance test module obtains hardware information (such as a hardware model, a hardware device number, etc.) and/or receives a test result of the computing device 110. Additionally, as discussed above, the determination rule of the first performance may also be associated with the type of the rendering task. In this case, if the first performance is calculated by the cloud performance test module, the computing device 110 may also send information related to the type of the rendering task (such as a name and an identifier of the rendering task) to the cloud performance test module. Next, the cloud performance test module determines the first performance and sends the determined first performance to the computing device 110 through a corresponding message. Based on the message, the computing device 110 may correspondingly determine the first performance. In this way, the determination process of the first performance will be more consistent and unified.

Through the above process, the first performance associated with the local rendering mode can be determined.

### Determining the Second Performance

In some embodiments, determining the second performance includes obtaining at least one network performance parameter associated with the cloud rendering mode. It would be appreciated that the network performance parameter in the present disclosure refers to any appropriate parameter that can characterize and measure the performance of the cloud rendering mode.

An example of the network performance parameter is a network bandwidth. Another example of the network performance parameter is a network latency. Other examples of the network performance parameter include network jitter, a packet loss rate, and a signal strength. In some embodiments, a value of the at least one network performance parameter may be obtained through testing. In a specific embodiment, the computing device 110 establishes a connection with a cloud (such as the cloud performance test module) and sends data packets within a predetermined period of time, and the size of the network bandwidth is evaluated through the detection of the data packet transmission process. Additionally, the sent data packets may include timestamp information, and the network latency may be obtained according to the timestamp information. Additionally, the sent data packets may also carry numbers, and the jitter and the packet loss rate may be obtained according to the numbers. It should be understood that the above process of obtaining the value of the network performance parameter is only an example. In other embodiments, the network performance parameter may be other appropriate parameters, and the value of the network performance parameter may be obtained through any existing or future-defined manner. The embodiments of the present disclosure are not limited in this respect.

Further, in the present disclosure, a sender of data packets may be either the computing device 110 or the cloud performance test module. In addition, the transmitted data packets may be either unidirectional or bidirectional. Further, the recipient may send a response data packet in response to receiving the data packet. Based on the above data packet interaction process, a value of the at least one network performance parameter may be determined.

Alternatively or additionally, different network performance parameters may also have different weights, and the second performance may also be calculated based on the weights of the at least one network performance parameter. In some embodiments, the weights of different network performance parameters are pre-configured, such as the network bandwidth and/or the latency having a high first weight, and the jitter having a low second weight. Alternatively, the weights of different network performance parameters may also be dynamically determined based on the type of the rendering task.

In some embodiments, the second performance may be measured by a score. Specifically, different values of the network performance parameter correspond to different scores. As a specific embodiment, the second performance may be calculated by the following equation (2).

$$Second performance = Score of first network parameter * First weight + Score of Mth network parameter * Nth weight \qquad ( 2 )$$

where N is an integer greater than or equal to 1. In some embodiments, the determination rule of the second performance may be pre-configured and stored. Table 2 below shows an example of the determination rule of the second performance.

TABLE 2
Example of determination rule of the second performance

| Network | | | |
|---|---|---|---|
| performance | | | |
| parameter | Weight | Test value | Score |
| Network | W1 (For example, | B1 (For example, | S1 (For example, |
| bandwidth | the first weight) | the first | the first score) |
| | | bandwidth range) | |
| | | B2 (For example, | S2 (For example, |
| | | the second | the second score) |
| | | bandwidth range) | |
| Latency | W2 (For example, | D1 (For example, | S3 (For example, |
| | the second weight) | the first | the third score) |
| | | latency range) | |
| | | D2 (For example, | S4 (For example, |
| | | the second | the fourth score) |
| | | latency range) | |
| . . . | . . . | . . . | . . . |
| Packet | W3 (For example, | L1 (For example, | S5 (For example, |
| loss rate | the third weight) | the first packet | the fifth score) |
| | | loss rate range) | |

In the specific embodiment in Table 2, if the network bandwidth belongs to the first bandwidth range, the latency belongs to the first latency range, and the packet loss rate belongs to the first packet loss rate range, the second performance will be calculated as the first weight*the first score+the second weight*the third score+the third weight*the fifth score through equation (2).

It should be understood that the determination rule of the second performance in Table 2 is only an example. In other words, the numbers and values of the network performance parameters, the weights, the test values, and the scores shown in Table 2 are all illustrative. In other embodiments, the determination rule of the second performance may be properly defined according to actual needs. It should also be understood that the above equation (2) is also only an example. In other embodiments, the second performance may also be determined by other equations. More importantly, the characterization of the second performance by the score is only illustrative. In other embodiments, the second performance may also be characterized by other parameters, such as a performance level. In short, the present disclosure is not limited in the specific implementation of determining the first performance through the value and the weight of the at least one network performance parameter.

In some embodiments, the calculation of the second performance may be performed by the computing device 110. Alternatively or additionally, in some embodiments, the second performance may also be calculated by the cloud performance test module. In this case, the cloud performance test module obtains the value of the at least one network performance parameter, which may be measured by the cloud performance test module itself or received from the computing device 110. Additionally, as discussed above, the determination rule of the second performance may also be associated with the type of the rendering task. In this case, if the second performance is calculated by the cloud performance test module, the computing device 110 may also send information related to the type of the rendering task (such as a name and an identifier of the rendering task) to the cloud performance test module. Next, the cloud performance test module determines the second performance and sends the determined second performance to the computing device 110 through a corresponding message. Based on the message, the computing device 110 may correspondingly determine the second performance. In this way, the determination process of the second performance will be more consistent and unified.

Through the above example process, the second performance associated with the cloud rendering mode can be determined.

In some embodiments, the first performance and the second performance may be used as a basis for selecting the target rendering mode. As shown in FIG. 2, at block 220, the computing device 110 determines, at least partially based on the first performance and the second performance, a target rendering mode from the local rendering mode and the cloud rendering mode for executing a rendering task.

In some embodiments, the computing device 110 automatically determines, as the target rendering mode, the one with better performance in the local rendering mode and the cloud rendering mode. Optionally, the computing device 110 presents the determined target rendering mode to the user through the user interface 152.

Alternatively, in some embodiments, the target rendering mode may be selected by the user based on the first performance and the second performance. As an example, the computing device 110 presents, through the user interface 152, information of the first performance and the second performance and a visual element for receiving the user selection 130 for determining the target rendering mode to the user. The computing device 110 determines the target rendering mode based on the user selection 130.

In addition, in addition to the first performance and the second performance, the target rendering mode may also be determined based on other factors. An example factor is the performance requirements of the rendering task, such as requirements for latency, image quality, and rendering duration. Another example factor is the type of the rendering task, such as adding special effects and blurring the background. Another example factor is a storage location of the data to be rendered, such as on the cloud or locally. Other example factors include the priority of the rendering task and the size of the data to be rendered.

It should be understood that the above example factors are only for illustrative purposes. In other embodiments, other factors may also be considered when determining the target rendering mode. The embodiments of the present disclosure are not limited in this respect.

Further, similar to the first performance and the second performance, the above example factors may also be presented to the user through the user interface 152, so that the user can make a more suitable rendering strategy.

At block 230, the computing device 110 executes the rendering task based on the target rendering mode.

As discussed in the present disclosure, in some embodiments, the computing device 110 may dynamically switch between the local rendering mode and the cloud rendering mode. In this way, when the performance of the rendering mode in use decreases, the rendering mode may be switched to another rendering mode to continue to execute the rendering task.

In some embodiments, in response to the cloud rendering mode being selected as the target rendering mode, the above second performance is continuously monitored during the execution of the rendering task. In an embodiment, the second performance is detected periodically or continuously. In another embodiment, the second performance is triggered to be detected in response to a predefined event. An example of the predefined event is a user input, such as a user inputting an instruction of expecting to view the second performance. Another example of the predefined event is the detection of a deterioration of a network environment, such as a network connection interruption, a weakening of a network connection signal strength, or insufficient network bandwidth. It should be understood that the above examples of the predefined events are only illustrative. In other embodiments, the computing device 110 may trigger the monitoring of the second performance in response to other predefined events. Further, if the computing device 110 detects that the second performance drops below a first threshold performance, the target rendering mode is switched to the local rendering mode (if the local rendering mode is available).

In addition, in order to prevent frequent switching of the rendering mode (that is, the ping-pong effect), the computing device 110 does not immediately switch to the local rendering mode after detecting that the second performance drops below the first threshold performance. In contrast, when the computing device 110 determines that a duration for which the second performance drops below the first threshold performance reaches a first threshold duration, the target rendering mode is switched to the local rendering mode.

Alternatively, if the local rendering mode is selected as the target rendering mode, the above second performance is continuously monitored during the execution of the rendering task. In an embodiment, the second performance is detected periodically or continuously. In another embodiment, the second performance is triggered to be detected in response to a predefined event. An example of the predefined event is a user input, such as a user inputting an instruction expecting to view the second performance. Another example of the predefined event is the detection of an improvement of a network environment. It should be understood that the above examples of the predefined events are only illustrative. In other embodiments, the computing device 110 may trigger the monitoring of the second performance in response to other predefined events. Further, if the computing device 110 detects that the second performance rises above a second threshold performance, the target rendering mode is switched to the cloud rendering mode.

Similarly, in order to prevent frequent switching of the rendering mode (that is, the ping-pong effect), the computing device 110 does not immediately switch to the cloud rendering mode after detecting that the second performance rises above the first threshold performance. In contrast, when the computing device 110 determines that a duration for which the second performance rises above the second threshold performance reaches a second threshold duration, the target rendering mode is switched to the cloud rendering mode.

Alternatively, in some embodiments, if the local rendering mode is selected as the target rendering mode, the first performance is continuously monitored during the execution of the rendering task. In an embodiment, the first performance is detected periodically or continuously. In another embodiment, the detection of the first performance is triggered in response to a predefined event. An example of the predefined event is a user input, such as a user inputting an instruction expecting to view the first performance. Another example of the predefined event is the detection of a deterioration of hardware performance, such as a decrease in CPU running speed and insufficient storage space. It should be understood that the above examples of the predefined events are only illustrative. In other embodiments, the computing device 110 may trigger the monitoring of the first performance in response to other predefined events. Further, if the computing device 110 detects that the first performance drops below a third threshold performance, the target rendering mode is switched to the cloud rendering mode.

In addition, in order to prevent frequent switching of the rendering mode (that is, the ping-pong effect), the computing device 110 does not immediately switch to the cloud rendering mode after detecting that the first performance drops below the third threshold performance. In contrast, when the computing device 110 determines that a duration for which the first performance drops below the third threshold performance reaches a third threshold duration, the target rendering mode is switched to the cloud rendering mode.

Alternatively, if the cloud rendering mode is selected as the target rendering mode, the above first performance is continuously monitored during the execution of the rendering task. An example of the predefined event is a user input, such as a user inputting an instruction of expecting to view the first performance. Another example of the predefined event is the detection of an improvement of the hardware performance. It should be understood that the above examples of the predefined events are only illustrative. In other embodiments, the computing device 110 may trigger the monitoring of the first performance in response to other predefined events. Further, if the computing device 110 detects that the first performance rises above a fourth threshold performance, the target rendering mode is switched to the local rendering mode.

Similarly, in order to prevent frequent switching of the rendering mode (that is, the ping-pong effect), the computing device 110 does not immediately switch to the local rendering mode after detecting that the first performance rises above the first threshold performance. In contrast, when the computing device 110 determines that a duration for which the first performance rises above the fourth threshold performance reaches a fourth threshold duration, the target rendering mode is switched to the local rendering mode.

It should be understood that the above process of switching the rendering mode is only an example. Therefore, in its embodiment, both the first performance and the second performance are detected, and the switching of the rendering mode is determined based on the first performance and the second performance.

Further, the switching of the rendering mode may be implemented as determining the target rendering mode again. For the purpose of simplicity only, similar descriptions will not be discussed again.

In some embodiments, when it is determined that the target rendering mode needs to be switched, a prompt may be presented to the user. The presented information includes but is not limited to the latest determined first performance and/or second performance, and the like. Based on the prompt information, the user may re-select the target rendering mode.

In this way, the target rendering mode can be switched between local rendering and cloud rendering dynamically, so that the advantages of the two rendering modes can be fully utilized.

### Example Apparatus and Device

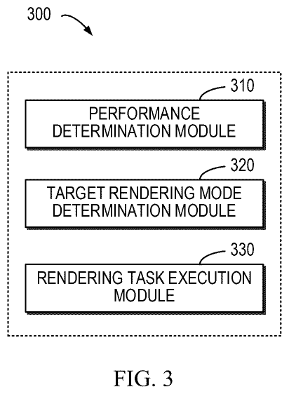

FIG. 3 shows a block diagram of an image processing apparatus 300 according to some embodiments of the present disclosure. The apparatus 300 may be implemented as or included in the computing device 110. Each module/component in the apparatus 300 may be implemented by hardware, software, firmware, or any combination thereof.

As shown, the apparatus 300 includes a performance determination module 310 configured to determine a first performance associated with a local rendering mode and a second performance associated with a cloud rendering mode. The apparatus 300 further includes a target rendering mode determination module 320 configured to determine, at least partially based on the first performance and the second performance, a target rendering mode from the local rendering mode and the cloud rendering mode for executing a rendering task. The apparatus 300 further includes a rendering task execution module 330 configured to execute the rendering task based on the target rendering mode.

In some embodiments, the performance determination module 310 is further configured to: obtain at least one hardware performance parameter associated with the local rendering; and determine the first performance based on at least one of a value or a weight of the at least one hardware performance parameter.

In some embodiments, the performance determination module 310 is further configured to: obtain at least one network performance parameter associated with the cloud rendering; and determine the second performance based on at least one of a value or a weight of the at least one network performance parameter.

In some embodiments, the target rendering mode determination module 320 is further configured to: determine the target rendering mode based on the first performance and the second performance and a performance requirement of the rendering task.

Alternatively or additionally, in some embodiments, the target rendering mode determination module 320 is further configured to: determine the target rendering mode based on the first performance and the second performance and a type of the rendering task.

In some embodiments, the target rendering mode determination module 320 is further configured to: determine the target rendering mode based on the first performance and the second performance and a priority of the rendering task.

In some embodiments, the target rendering mode determination module 320 is further configured to: determine the target rendering mode based on the first performance and the second performance and a size of data to be rendered by the rendering task.

In some embodiments, the target rendering mode determination module 320 is further configured to: determine the target rendering mode based on the first performance and the second performance and a storage location of the data to be rendered by the rendering task.

In some embodiments, the target rendering mode determination module 320 is further configured to: present an indication of the first performance and the second performance to a user; and receive a user selection 130 of the user for determining the target rendering mode.

In some embodiments, the apparatus 300 further includes a first switching module configured to: in response to the cloud rendering mode being selected as the target rendering mode, monitor the second performance during the execution of the rendering task; and switch the target rendering mode to the local rendering mode in response to monitoring that the second performance drops below a first threshold performance.

In some embodiments, the first switching module is further configured to: switch the target rendering mode to the local rendering mode in response to a duration for which the second performance drops below the first threshold performance reaching a first threshold duration.

In some embodiments, the apparatus 300 further includes a second switching module configured to: in response to the local rendering mode being selected as the target rendering mode, monitor the second performance during the execution of the rendering task; and switch the target rendering mode to the cloud rendering mode in response to monitoring that the second performance rises above a second threshold performance.

In some embodiments, the second switching module is further configured to: switch the target rendering mode to the cloud rendering mode in response to a duration for which the second performance rises above the second threshold performance reaching a second threshold duration.

In some embodiments, the apparatus 300 is a virtual livestream or virtual meeting client device.

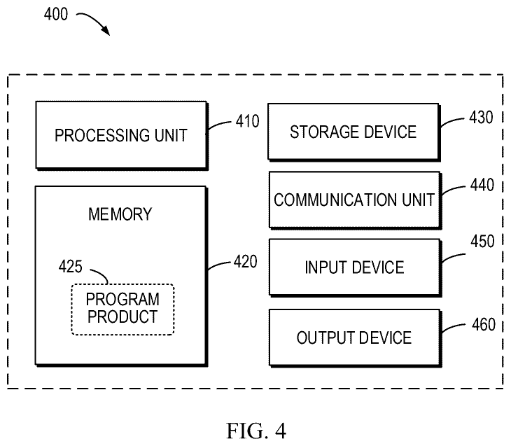

FIG. 4 shows a block diagram of a computing device/system 400 in which one or more embodiments of the present disclosure may be implemented. It should be understood that the computing device/system 400 shown in FIG. 4 is only exemplary and should not constitute any limitation on the functions and scope of the embodiments described herein. The computing device/system 400 shown in FIG. 4 may be used to implement the computing device 110 of FIG. 1.

As shown in FIG. 4, the computing device/system 400 is in the form of a general-purpose computing device. Components of the computing device/system 400 may include, but are not limited to, one or more processors or processing units 410, a memory 420, a storage device 430, one or more communication units 440, one or more input devices 450, and one or more output devices 460. The processing unit 410 may be a physical or virtual processor and can execute various processes according to programs stored in the memory 420. In a multi-processor system, multiple processing units execute computer-executable instructions in parallel to improve the parallel processing capability of the computing device/system 400.

The computing device/system 400 generally includes a plurality of computer storage media. Such media may be any available media accessible by the computing device/system 400, including but not limited to volatile and non-volatile media, and removable and non-removable media. The memory 420 may be a volatile memory (for example, a register, a cache, a random access memory (RAM)), a non-volatile memory (for example, a read-only memory (ROM), an electrically erasable programmable read-only memory (EEPROM), a flash memory), or some combination thereof. The storage device 430 may be a removable or non-removable medium, and may include a machine-readable medium, such as a flash drive, a disk, or any other medium, which can be used to store information and/or data (for example, training data for training) and can be accessed within the computing device/system 400.

The computing device/system 400 may further include additional removable/non-removable, volatile/non-volatile storage media. Although not shown in FIG. 4, a disk drive for reading from or writing to a removable, non-volatile disk (for example, a “floppy disk”) and an optical disk drive for reading from or writing to a removable, non-volatile optical disk can be provided. In these cases, each drive may be connected to a bus (not shown) through one or more data medium interfaces. The memory 420 may include a computer program product 425 having one or more program modules configured to perform various methods or actions of various embodiments of the present disclosure.

The communication unit 440 enables communication with other computing devices through a communication medium. Additionally, the functions of the components of the computing device/system 400 may be implemented by a single computing cluster or multiple computing machines capable of communicating through a communication connection. Therefore, the computing device/system 400 may operate in a networked environment using a logical connection with one or more other servers, network personal computers (PCs), or another network node.

The input device 450 may be one or more input devices, such as a mouse, a keyboard, and a trackball. The output device 460 may be one or more output devices, such as a display, a speaker, and a printer. The computing device/system 400 may also communicate with one or more external devices (not shown) as needed through the communication unit 440, where the external devices such as storage devices and display devices, communicate with one or more devices that enable the user to interact with the computing device/system 400, or communicate with any device (for example, a network card, a modem, etc.) that enables the computing device/system 400 to communicate with one or more other computing devices. Such communication may be performed via an input/output (I/O) interface (not shown).

According to an example implementation of the present disclosure, there is provided a computer-readable storage medium having stored thereon computer-executable instructions or a computer program, where the computer-executable instructions or the computer program are executed by a processor to implement the method described above.

According to an example implementation of the present disclosure, there is further provided a computer program product, which is tangibly stored on a non-transitory computer-readable medium and includes computer-executable instructions, where the computer-executable instructions are executed by a processor to implement the method described above.

Various aspects of the present disclosure are described herein with reference to flowcharts and/or block diagrams of a method, an apparatus, a device, and a computer program product implemented according to the present disclosure. It should be understood that each block of the flowchart and/or the block diagram and a combination of the blocks in the flowchart and/or the block diagram can be implemented by computer-readable program instructions.

These computer-readable program instructions may be provided to a processing unit of a general-purpose computer, a special-purpose computer, or another programmable data processing apparatus to produce a machine, such that the instructions, when executed by the processing unit of the computer or another programmable data processing apparatus, generate a device for implementing the functions/actions specified in one or more blocks in the flowchart and/or the block diagram. These computer-readable program instructions may also be stored in a computer-readable storage medium, and these instructions enable a computer, a programmable data processing apparatus, and/or another device to work in a specific manner. Therefore, the computer-readable medium storing the instructions includes a product, which includes instructions for implementing various aspects of the functions/actions specified in one or more blocks in the flowchart and/or the block diagram.

The computer-readable program instructions may be loaded onto a computer, another programmable data processing apparatus, or another device, so that a series of operation steps are performed on the computer, another programmable data processing apparatus, or another device to produce a computer-implemented process, such that the instructions executed on the computer, another programmable data processing apparatus, or another device implement the functions/actions specified in one or more blocks in the flowchart and/or the block diagram.

The flowcharts and block diagrams in the accompanying drawings show a possible system architecture, functions, and operations of the system, method, and computer program product implemented according to the present disclosure. In this regard, each block in the flowchart or block diagram may represent a module, program segment, or part of an instruction, and the module, program segment, or part of an instruction contains one or more executable instructions for implementing the specified logical functions. In some alternative implementations, the functions marked in the blocks may also occur in an order different from that marked in the accompanying drawings. For example, two consecutive blocks can actually be executed substantially in parallel, or they can sometimes be executed in the reverse order, depending on the function involved. It should also be noted that each block in the block diagram and/or the flowchart, and a combination of the blocks in the block diagram and/or the flowchart may be implemented by a dedicated hardware-based system that executes specified functions or actions, or may be implemented by a combination of dedicated hardware and computer instructions.

The implementations of the present disclosure have been described above. The foregoing descriptions are exemplary, not exhaustive, and are not limited to the disclosed implementations. Many modifications and changes are obvious to those of ordinary skill in the art without departing from the scope and spirit of the described implementations. The selection of terms used herein is intended to best explain the principles, practical applications, or improvements to the technology in the market of the implementations, or to enable other ordinary skill in the art to understand the implementations disclosed herein.

I/We claim:

1. An image rendering method, comprising:
determining a first performance associated with a local rendering mode and a second performance associated with a cloud rendering mode;
determining, at least partially based on the first performance and the second performance, a target rendering mode from the local rendering mode and the cloud rendering mode for executing a rendering task; and
executing the rendering task based on the target rendering mode.

2. The method according to claim 1, wherein determining the first performance comprises:
obtaining at least one hardware performance parameter associated with the local rendering; and
determining the first performance based on at least one of a value or a weight of the at least one hardware performance parameter.

3. The method according to claim 1, wherein determining the second performance comprises:
obtaining at least one network performance parameter associated with the cloud rendering; and
determining the second performance based on at least one of a value or a weight of the at least one network performance parameter.

4. The method according to claim 1, wherein determining the target rendering mode comprises:
determining the target rendering mode based on the first performance and the second performance and further based on at least one of the following:
a performance requirement of the rendering task,
a type of the rendering task,
a priority of the rendering task,
a size of data to be rendered by the rendering task, or
a storage location of the data to be rendered by the rendering task.

5. The method according to claim 1, wherein determining the target rendering mode comprises:
presenting an indication of the first performance and the second performance to a user; and
receiving a user selection of the user for determining the target rendering mode.

6. The method according to claim 1, further comprising:
in response to the cloud rendering mode being selected as the target rendering mode,
monitoring the second performance during the execution of the rendering task; and
in response to monitoring that the second performance drops below a first threshold performance, switching the target rendering mode to the local rendering mode.

7. The method according to claim 6, wherein switching the target rendering mode to the local rendering mode comprises:
in response to a duration for which the second performance drops below the first threshold performance reaching a first threshold duration, switching the target rendering mode to the local rendering mode.

8. The method according to claim 1, further comprising:
in response to the local rendering mode being selected as the target rendering mode,
monitoring the second performance during the execution of the rendering task; and
in response to monitoring that the second performance rises above a second threshold performance, switching the target rendering mode to the cloud rendering mode.

9. The method according to claim 8, wherein switching the target rendering mode to the cloud rendering mode comprises:
in response to a duration for which the second performance rises above the second threshold performance reaching a second threshold duration, switching the target rendering mode to the cloud rendering mode.

10. The method according to claim 1, wherein the rendering task is related to a virtual livestream or virtual meeting rendering task.

11. An image rendering apparatus, comprising:
a performance determination module configured to determine a first performance associated with a local rendering mode and a second performance associated with a cloud rendering mode;
a target rendering mode determination module configured to determine, at least partially based on the first performance and the second performance, a target rendering mode from the local rendering mode and the cloud rendering mode for executing a rendering task; and
a rendering task execution module configured to execute the rendering task based on the target rendering mode.

12. The apparatus according to claim 11, further comprising:
a first switching module configured to in response to the cloud rendering mode being selected as the target rendering mode,
monitor the second performance during the execution of the rendering task; and
in response to monitoring that the second performance drops below a first threshold performance, switch the target rendering mode to the local rendering mode.

13. The apparatus according to claim 10, wherein the image rendering apparatus is a virtual livestream or virtual meeting client device.

14. An electronic device, comprising:
at least one processing unit, and
at least one memory coupled to the at least one processing unit and storing instructions executable by the at least one processing unit, wherein the instructions, when executed by the at least one processing unit, cause the device to perform the method according to any one of claims 1 to 10.

15. A computer-readable storage medium having stored thereon a computer program, wherein the computer program is executed by a processor to implement the method according to any one of claims 1 to 10.
